(19) United States
(12) Patent Application Publication
(10) Pub. No.: US 2010/0131650 A1
(43) Pub. Date: May 27, 2010

(54) Methods and Apparatus to Support Network Policy Managers

(76) Inventors: Chou Lan Pok, San Ramon, CA (US); Richard Kuo, Mountain View, CA (US); Tingting Lu, Alpharetta, GA (US); James Fan, San Ramon, CA (US)

Correspondence Address: AT&T Legal Department - HFZ;ATTN. Patent Docketing, One AT&T Way, Room 2A-207, Bedminstor, NJ, 07921, US

(21) Appl. No.: 12/477,675

(22) Filed: Jun. 3, 2009

Related U.S. Application Data
(60) Provisional application No. 61/118,331, filed on Nov. 26, 2008.

(51) Int. Cl. G06F 15/173

(52) U.S. Cl. 709/226

(57) ABSTRACT

Methods and apparatus to support network policy managers are disclosed herein. An example method for use in a communication system includes receiving an adjustment request from a user premises to temporarily adjust a policy defining a bundled service associated with the user premises, the bundled service including a first service assigned a first percentage of a network resource and a second service assigned a second percentage of the network resource; automatically adjusting the policy such that the first service is assigned a third percentage of the network resource, wherein the third percentage is greater than the first percentage; receiving a notification of a termination of an application associated with the first service; and readjusting the policy such that the first service is assigned the first percentage in response to the notification.

### RELATED APPLICATION

This patent claims the benefit of U.S. Provisional Patent Application Ser. No. 61/118,331, entitled “Methods and Apparatus to Support Policy Manager Interaction with Various Operational Support Systems,” filed on Nov. 26, 2008, which is hereby incorporated herein in its entirety.

### FIELD OF THE DISCLOSURE

The present disclosure relates generally to networks and, more particularly, to methods and apparatus to support network policy managers.

### BACKGROUND

Service providers offer products and services such as, for example, voice, data, and video applications across both wired and wireless infrastructures. These products and services have different policy requirements to address Quality of Services (QoS), charging, and access control issues. This has prompted service providers to deploy policy manager systems to support the products and services.

### BRIEF DESCRIPTION OF THE DRAWINGS

FIG. 1 is a schematic illustration of an example communication system.

FIG. 2 is a block diagram illustrating example implementations of the authentication/authorization module, the application server(s), the network element, the policy manager, and the OSS/BSS of the example service provider of FIG. 1.

FIG. 3 illustrates an example physical interface architecture through which the components illustrated in FIG. 2 interact and/or communicate.

FIG. 4 is a sequence diagram representing machine readable instructions that may be executed to implement the example components of the example service provider of FIGS. 1, 2 and/or 3.

FIG. 5 is a sequence diagram representing machine readable instructions that may be executed to implement the example components of the example service provider of FIGS. 1, 2 and/or 3.

FIG. 6 is a sequence diagram representing machine readable instructions that may be executed to implement the example components of the example service provider of FIGS. 1, 2 and/or 3.

FIG. 7 is a block diagram of an example processor system that may be used to execute the machine readable instructions of FIGS. 4, 5, and/or 6 and/or to implement the example components of the example service provider of FIGS. 1, 2, and/or 3.

### DETAILED DESCRIPTION

Although the following discloses example methods, apparatus, systems, and/or articles of manufacture including, among other components, firmware and/or software executed on hardware, it should be noted that such methods, apparatus, systems, and/or articles of manufacture are merely illustrative and should not be considered as limiting. For example, it is contemplated that any or all of the firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Improvements in communication technology have allowed service providers to offer customers an increasingly broad range of services. For example, service providers have integrated services to provide customers combined voice, data, and/or video services (sometimes referred to as triple-play service). As used herein in connection with integrated services, ‘data service’ refers to services providing access to electronic information sources such as, for example, web servers, file transfer protocol (ftp) servers, database servers, mail servers, file servers, etc., via a transmission medium such as, for example, the Internet. Service providers are also offering customers additional or alternative combinations of these and/or other services such as, for example, voice over Internet protocol (VoIP) and/or Internet protocol television (IPTV).

To deliver integrated services to customers, a service provider develops and implements a plurality of service bundles from which the customer can choose. The service bundles are prescribed by policies that define the terms, conditions, capabilities, etc. associated with the selected integrated service. Typically, the policies are conceived by product developers (e.g., business strategists, marketing professionals, etc.) and implemented by technicians (e.g., network engineers, programmers, etc.). The technicians inform the product developers as to what services and/or combinations thereof can be implemented on a network used to delivery the services to the customers.

The network has limitations (e.g., maximum bandwidth, transmission speed, data rates, etc.) and, thus, network resources are allocated to customers according to the selected service bundle(s) (sometimes referred to as product bundle(s)) and the corresponding polic(ies). For example, a first customer premises having a first service bundle assigned thereto is provided with a certain bandwidth dedicated to transmission of voice, data, and/or video information. The amount of bandwidth provided to the customer depends on which service bundle has been selected. In many instances, service bundles providing a greater amount of bandwidth or a greater amount of services are more expensive. As described in greater detail below, the bandwidth provided to the customer is apportioned such that a first percentage of the bandwidth is dedicated to voice information, a second percentage to data information, and a third percentage to video information. Further, the policy corresponding to the first service bundle defines which of a plurality of services or features (e.g., access to one or more non-basic sources of information such as, for example, premium channels of a television service, video on-demand, or IPTV) the customer has selected.

Once a bundled service is complete and offered to customers, the service provider is charged with maintaining the network on which the integrated services are offered and with maintaining steady delivery of the services outlined in the policy of each customer. Some service providers implement a policy manager to perform these and other tasks. Typically, the policy manager interacts with an operational support system (OSS) and/or a business support system (BSS), which are sometimes referred to as a single unit using the term operational support system/business support system (OSS/BSS). Generally, the policy manager and the OSS/BSS interact using one or more interfaces (e.g., at interface touchpoints) that enable network technicians to, for example, implement the customer policies.

The example methods, apparatus, systems, and/or articles of manufacture described herein support such interactions between a policy manager, an OSS/BSS, and/or additional or alternative components utilized by a service provider (e.g., application servers, network elements, and/or authentication servers). In particular, the example methods, apparatus, systems, and/or articles of manufacture described herein enable service providers to dynamically modify the policies defining the service bundles being delivered to premises associated with the customers. For example, using the example methods, apparatus, systems, and/or articles of manufacture described herein, a service provider can reallocate a certain parameter (e.g., bandwidth) of individual services of an integrated service (e.g., triple-play service). That is, in response to, for example, a customer request, the service provider can redefine the policy associated with a requesting customer such that a first component of the integrated service (e.g., a data service) is allocated (e.g., temporarily or permanently) some or all of a network capability (e.g., bandwidth) previously allocated to a second component of the integrated service (e.g., video services). Thus, as described in greater detail below, the example methods, apparatus, systems, and/or articles of manufacture enables customers or users at a premises to request (e.g., via a graphical user interface provided by a service provider on a television, website, and/or any other suitable user interface) real-time alterations to the polic(ies) defining the allocation of network resource(s) to the communication equipment of the user premises.

Additionally or alternatively, such a reallocation of network resources (e.g., bandwidth) can be automatically performed by the service provider in response to detecting a some level of service failures or session rejections (e.g., an amount exceeding a threshold) that can potentially be avoided (e.g., temporarily or permanently) via the reallocation of network resource(s). Additionally or alternatively, such a reallocation of network resources (e.g., bandwidth) can be performed by the service provider during a customer care session and/or maintenance episode or appointment. In such instances, the reallocation of network services may assist the service provider in performing, for example, a root cause analysis. As described in greater below, the one or more of the policy adjustments described herein can be temporary, periodic, or permanent.

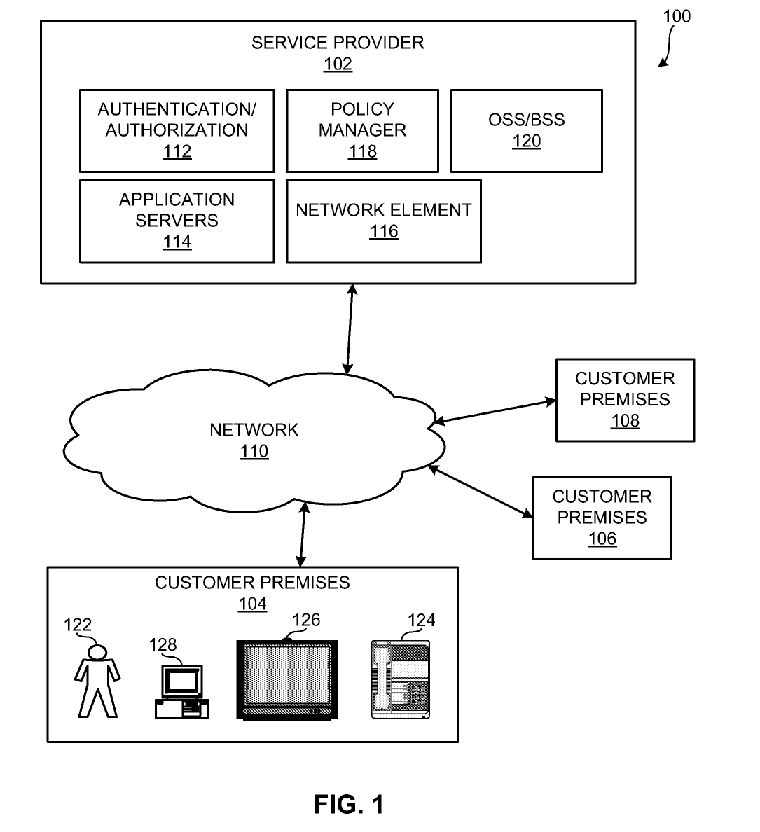

FIG. 1 is an example communication system 100 capable of implementing the example methods, apparatus, systems, and/or articles of manufacture described herein. The example communication system 100 of FIG. 1 can be implemented using any type of access communication system, such as, for example, a fiber optic communication system implementing Fiber to the Home or Fiber to the Curb (e.g., such as AT&T's Project Lightspeed®), a digital subscriber line (DSL) communication system (e.g., such as a DSL system implemented using asymmetric DSL (ADSL), very high data rate DSL (VDSL), etc.), a cable television communication system, a satellite communication system, a microwave communication system, a mobile telephone communication system, a public switched telephone (PSTN) communication system, etc. The example communication system 100 of FIG. 1 is further configured to support call processing associated with VoIP telephony and media services associated with IPTV.

The example communication system 100 of FIG. 1 includes a service provider 102 and is configured to provide communication services to a plurality of customer or user premises 104, 106, and 108 via a network 110. The example network 110 of FIG. 1 can be implemented by, for example, AT&T's Lightspeed® access network, which is an IP data access network that uses Fiber-to-the-x (FTTx) (e.g., Fiber to the Home) technology to provide broadband access to customers. In some examples, the network 110 of FIG. 1 may be implemented by 2G, 2.5G and/or 3G wireless networks, proprietary access networks, etc. Furthermore, some or all of the network 110 of FIG. 1 may be implemented by a single physical layer technology, although logically separated according to traffic type. For example, cable networks use a common physical cable link to provide service access. In particular, cable systems utilize low frequency bands for Internet data access and utilize high frequency bands for video services. Similarly, AT&T's Lightspeed network provides integrated time division multiplexed (TDM) voice, VoIP voice, Internet data and/or video services via a single broadband network infrastructure based on gigabit passive optical network (GPON)/broadband passive optical network (BPON) technology.

The network 110 employs a plurality of network elements, such as switches, routers, hubs, gateways, etc. to provide connectivity to communication equipment associated with the service provider 102 via a configured transmission path (sometimes referred to herein as a customer circuit). Customer circuits can be configured and/or designed according to such factors as geographic location, service type(s), and/or specifications, such as bandwidth requirements and/or transmission speed. In the interest of brevity and clarity, reference will be made herein to the example communication system 100 and/or the example network 110 of FIG. 1. The example methods, apparatus, systems, and/or articles of manufacture described herein are applicable to other types of systems and/or networks constructed using other technologies, topologies, and/or protocols, and/or to other types of communication sessions and/or communication applications, and/or to other service providers and/or types of service providers.

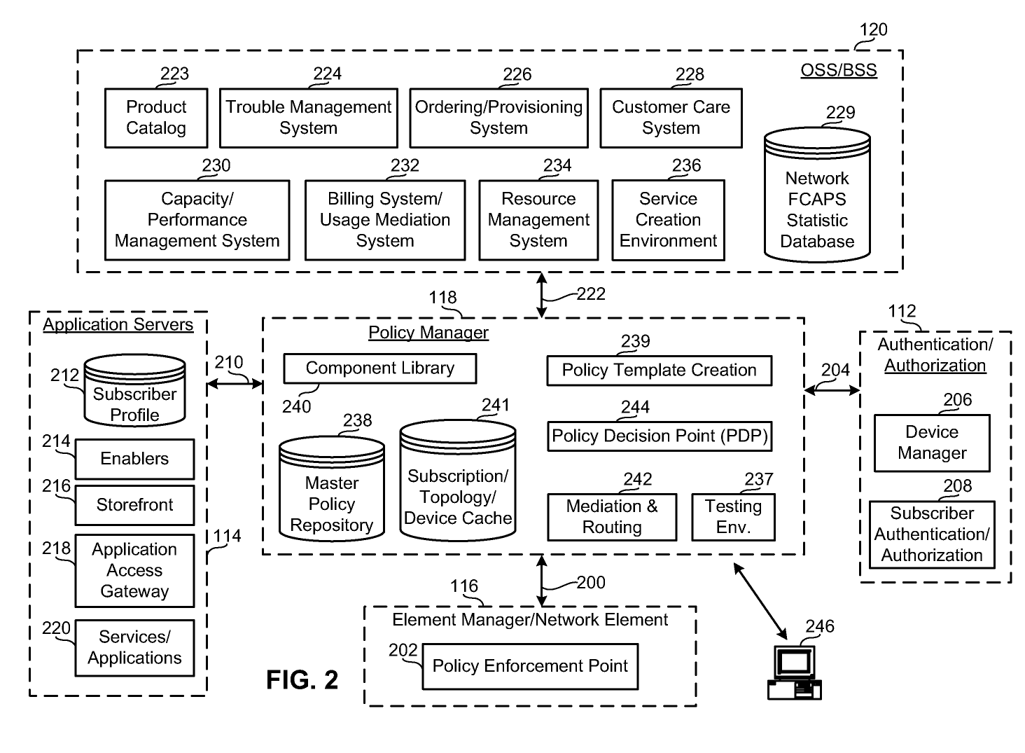

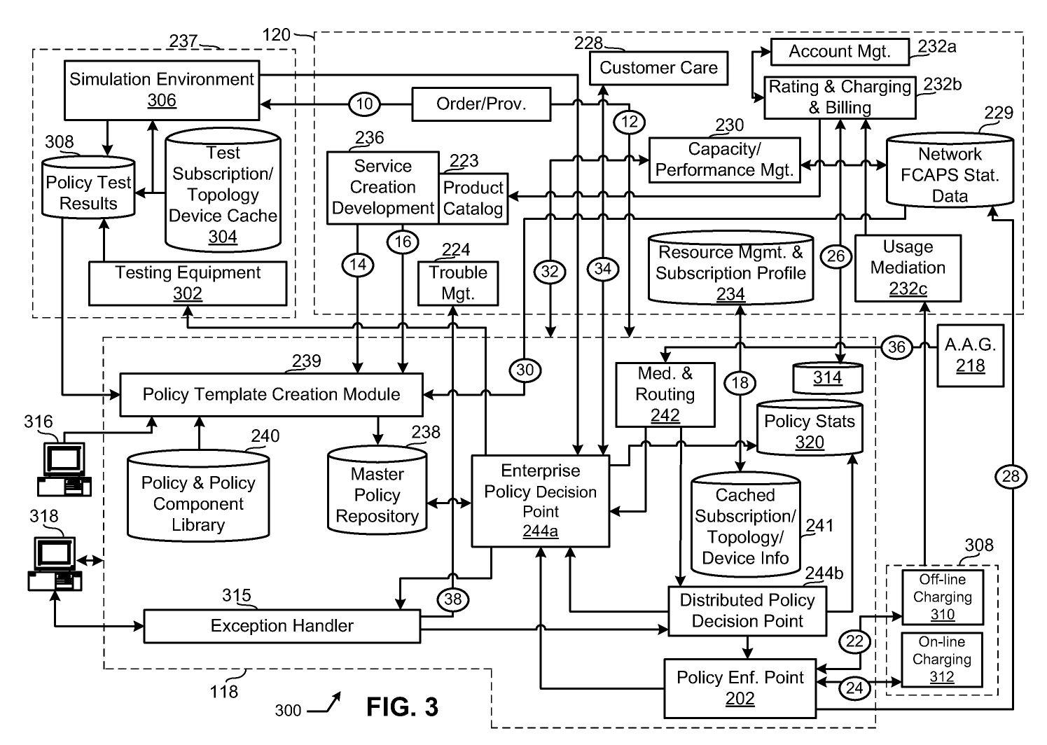

In the illustrated example of FIG. 1, the service provider 102 employs an authentication/authorization module 112, application server(s) 114, a network element 116, a policy manager 118, and an OSS/BSS 120. Generally, the authentication/authorization module 112, the application server(s) 114, the network element 116, the policy manager 118, and the OSS/BSS 120 are utilized by the service provider 102 to develop service bundles, to maintain delivery of the services provided thereby, and/or to perform the operations associated with the example methods, apparatus, systems, and/or articles of manufacture described herein. While the authentication/authorization module 112, the application server(s) 114, the network element 116, the policy manager 118, and the OSS/BSS 120 are shown in the example of FIG. 1 as implemented in the domain of the service provider 102, one or more the authentication/authorization module 112, the application server(s) 114, the network element 116, the policy manager 118, and/or the OSS/BSS 120 may be implemented outside the domain of the service provider 102 by, for example, a third party and/or a partner of the service provider 102. The components of the example service provider 102 of FIG. 1 are described in greater below in connection with FIGS. 2 and 3.

The example communication system 100 of FIG. 1 supports different types of customer premises equipment (CPE) devices located at the customer premises 104-108 and configured to distribute data received from the service provider 102 within the customer premises 104-108. In the illustrated example, the service provider 102 provides an integrated service (e.g., triple-play services) to the customer premises 104-108 via any number and/or type(s) of CPE devices located at the customer premises 104-108 such as, for example, a very high speed digital subscriber line (VDSL) modem, a cable modem, an optical terminal, etc.

The first customer premises 104 of FIG. 1 is an example premises associated with a customer 122 of the service provider 102 that has elected to receive an integrated service (e.g., triple-play service). In the illustrated example, the example service provider 102 delivers (e.g., via the network 110) the elected integrated service to a CPE device (e.g., a cable modem) located at the first premises 104 that distributes voice information to voice equipment 124 (e.g., a telephone wired to communicate over a PSTN, a cellular telephone, a voice over Internet protocol (VoIP) phone, an Analog Telephony Adapter (ATA), a soft telephone executing on a personal computer, etc.), audio/video information to a media presentation device 126 (e.g., any type of set-top-box, television, monitor, computer, etc.), and data services to data communication equipment 128 (e.g., a personal computer). Other supported communication equipment or devices include, for example, a dual-mode wireless/WiFi handheld device, a 2G, 2.5G and/or 3G wireless handheld device, IEEE 802.11x access points, WiFi access points, WiMax access points, xDSL modems, AT&T Lightspeed® Residential Gateways, etc.). While the first premises 104 of FIG. 1 includes example communication equipment 124, 126, and 128 configured to receive an example integrated service, additional or alternative services may be provided to additional or alternative communication equipment by additional or alternative service providers using the example methods, apparatus, systems, and/or articles of manufacture described herein. For example, customer associated with the first, second and/or third customer premises 104, 106 and/or 108 may elect to receive IPTV in addition to or in lieu of the services described in connection with the first customer premises 104.

As described above, the services provided to the first customer premises 104 and the allocation of resources in support thereof are defined and controlled by the service provider 102. For example, the policy manager 118 and the OSS/BSS 120 interact to create and maintain a policy defining the service bundle selected by the customer 122. The example methods, apparatus, systems, and/or articles of manufacture described herein enable the service provider 102 to alter one or more aspects of the service(s) being delivered to the premises 104. For example, the service provider 102 (e.g., via the application server(s) 114, the policy manager 118, the OSS/BSS 120, and/or other components of the service provider 102 as described in greater detail below) provides the customer 122 an option (e.g., via a graphical user interface provided by a service provider on a television, website, and/or any other suitable user interface) to alter (e.g., permanently or temporarily) the allocation of bandwidth defined in the policy assigned to the first customer premises 104 among the communication devices 124, 126, and 128 receiving the integrated service. The customer 122 may desire additional bandwidth for the personal computer 128 (e.g., relative to the bandwidth originally allotted to the personal computer 128 in the policy assigned to the first premises 104) when downloading a particularly large file from a network resource (e.g., a file server or mail server of the network 110). The policy that defines the bandwidth allocated to each of the voice equipment 124, the media presentation device 126, and the personal computer 128 can be altered (e.g., upon approval by the service provider 102) to accommodate a customer request to enable the large file to be downloaded using greater bandwidth. That is, the personal computer 128 gains access to a greater percentage of the total bandwidth provided to the customer premises 104 after the adjustment to the policy. In turn, one or more of the voice equipment 124 and the media presentation device 126 has access to a lower percentage of the total bandwidth provided to the customer premises 104.

Additionally or alternatively, the service provider 102 can perform the dynamic policy adjustments described herein in response to determining that one or more customer premises are not receiving sufficient quality of service. That is, the service provider 102 can modify (e.g., reallocate the percentages of bandwidth allocated to each of the service products (e.g., voice service, data service, and/or video service)) the policy defining the service bundle associated with the first customer premises 104 in response to detecting a certain amount of failures or problems (e.g., video on-demand rejections) at the first customer premises 104. The amount of failures or problems that can trigger a dynamic policy adjustment can be set to, for example, an adjustable threshold.

Additionally or alternatively, the service provider 102 can perform the dynamic policy adjustments described herein in support of customer care and/or network maintenance operations. The service provider 102 implements a customer care system to receive and address customer complaints and requests. In some instances, the dynamic policy adjustments described herein are helpful in addressing the customer complaints and/or requests. For example, a root cause analysis may be more easily and/or accurately performed if the policy defining the service bundle associated with the first premises 104 was adjusted according to an assessment of a network maintenance tool or customer support personnel. These and other example alterations of the policy assigned to the first customer premises 104 are described in greater detail herein.

FIG. 2 is a block diagram illustrating example implementations of the authentication/authorization module 112, the application server(s) 114, the network element 116, the policy manager 118, and the OSS/BSS 120 of the example service provider 102 of FIG. 1. The policy manager 118 interacts with the example network element 116 of FIG. 2 via one or more interfaces 200 referred to herein as southbound interfaces. The example network element 116 of FIG. 2 includes a policy enforcement point 202 to execute the policies and rules of the policy manager 118 over the network 110. For example, the policy enforcement point 202 may be a network device (e.g., a router configured to control the delivery of services to the customer premises 104, 106, and/or 108 via the network 110 according the policies assigned to the customer premises 104, 106, and 108). In some examples, the policy enforcement point 202 may be implemented as part of the policy manager 118.

The example policy manager 118 interacts with the example authentication/authorization module 112 of FIG. 2 via one or more interfaces 204 referred to herein as eastbound interfaces. The example authentication/authorization module 112 of FIG. 2 includes a device manager 206 and a subscription authentication/authorization module 208. Generally, the policy manager 118 utilizes the components of the authentication/authorization module 112 to ensure the users of the policy manager 118 or any other component associated with the service provider 102 have been approved to take the action(s) being requested or performed. The subscription authentication/authorization module 208 includes information related to a plurality of customers and the corresponding customer circuits. For example, the subscription authentication/authorization module 208 of FIG. 2 includes rules regarding permission levels assigned to users, passwords, usernames, etc. The device manager 206 enables customized support for a device authentication and management process (e.g., determining whether one or more users are restricted from certain resources and/or destinations) using the information of the authentication/authorization module 208.

The example policy manager 118 interacts with the example application server(s) 114 of FIG. 2 via one or more interfaces 210 referred to herein as westbound interfaces. The example application server(s) 114 of FIG. 2 include a subscriber profile database 212, enablers 214, a storefront 216, an application access gateway 218, and a services/applications module 220. The example subscription profile database 212 of FIG. 2 is a centralized data storage including profiles corresponding to the customers of the service provider 102. In the illustrated example, the subscriber profile database 212 includes a profile corresponding to the customer 122 of the first customer premises 104. The profile corresponding to the customer 122 includes information related to the policy assigned to the first customer premises 104 and the associated service bundle. That is, information related to the services chosen by the customer 122 (e.g., as defined by the corresponding policy) and the quality of service (QoS), transmission speed, bandwidth, etc. thereof is stored in connection with an entry assigned to the customer 122 in the example subscription profile database 212 of FIG. 2.

The example enablers 214 of FIG. 2 are a defined set of shared applications available for use to the customers of the service provider 102. When one or more of the enablers 214 is invoked at run-time, the enabler 214 can support a calling application to issue a policy request received by the policy manager 118. That is, the enablers 214 can, for example, assist in the retrieval of information from the subscriber profile database 212 and provide the same to, for example, the policy manager 118.

In the illustrated example, the storefront 216 is a portal to enable the customer 122 to purchase certain services (e.g., content related services). As described above, the service provider 102 develops a range of services that may or may not be combined to form an integrated service. In some instances, although the customer 122 has selected a certain integrated service, the customer 122 may desire access to one or more additional or alternative services or features offered by the service provider 102. These services or features are available in the storefront 216 (e.g., stored and accessible individually or as part of an integrated service service bundle).

The selection by the customer 122 of one or more of the services or features in the example storefront 216 may trigger a new policy request and/or an adjustment of policy request. The example application access gateway 218 of FIG. 2 is configured to address such requests by interacting with the policy manager 118 and/or the OSS/BSS 120. In particular, the example application access gateway 218 of FIG. 2 is a portal configured to receive such transactional oriented requests from, for example, the customer 122 and to deliver the same to the policy manager 118 as dynamic policy setting requests. The handling of the dynamic policy setting requests is described in greater detail below in connection with the policy manager 118 and in connection with FIGS. 3, 4, 5, and/or 6.

In the illustrated example, the application access gateway 218 is implemented within the domain of the service provider 102. That is, the example application access gateway 118 of FIG. 2 interacts with one or more customers of the service provider 102 and, in some instances, one or more other parties associated with the service provider 102 such as, for example, a partner service provider. However, in some examples, the application access gateway 218 is implemented outside the domain of the service provider 102. For example, the application access gateway 218 may be implemented by a third party that enables customers of a plurality of service providers to access the application access gateway 218. In such instances, when the application access gateway 218 receives a request from a customer for access to a service beyond the constraints of the policy assigned to the customer (e.g., when the application access gateway 218 is to provide at least temporary access to the requested service), the application access gateway 218 determines a desired manner to deliver the service. Delivery of the access to the service may include enabling the customer to pay for the access to service.

For example, the application access gateway 218 may determine to which service provider the requesting customer is currently subscribed. If the third party implementing the application access gateway 218 has an agreement (e.g., a fee arrangement) with the identified service provider, the requesting customer is charged an agreed upon fee for access to the service. In the absence of an agreement between the third party implementing the application access gateway 218 and the identified service provider, the application access gateway 218 negotiates a temporary agreement for a duration in which the requesting customer consumes the service. If an agreement cannot be reached, the application access gateway 218 can negotiate with alternative service provider(s) (e.g., service provider(s) deemed able to deliver the service to the requesting customer by determining the location of the requesting customer and gathering information regarding the capabilities of the requesting customer's device(s) and/or communication equipment). The negotiations with the service provider(s) may also include obtaining the network resources necessary to provide an expected QoS. In such instances, the native policy manager of the requesting customer is notified of any changes made to, for example, the service being delivered to the customer premises.

Similar to the storefront 216, the example services/applications 220 of FIG. 2 are resources provided by the service provider 102 and accessible by a customer (depending on the policy associated with the customer or customer premises). One of the services/applications 220 may be selected by a customer not having access to that particular service/application 220 (e.g., an IPTV resource) and, in response, a dynamic policy setting request may be generated. As described above, the application access gateway 218 is configured to receive such a request and to deliver the same to the policy manager 118.

The example policy manager 118 interacts with the example OSS/BSS 120 of FIG. 2 via one or more interfaces 222 referred to herein as northbound interfaces. The example OSS/BSS 120 of FIG. 2 includes a product catalog 223, a trouble management system 224, an ordering/provisioning system 226, a customer care system 228, a network FCAPS (fault, configuration, accounting, performance and/or security functions) statistic database 229, a capacity/performance management system 230, a billing/usage mediation system 232, a resource management system 234, and a service creation environment 236.

The example product catalog 223 of FIG. 2 stores the service bundles currently available to customers and/or service bundles scheduled to be available to customers at a later time. As described above, the service bundles are sets of integrated services (e.g., voice, video, and/or data services) that can be delivered together to, for example, the customer 122 at the first premises 104. As the network 110 improves or otherwise changes, additional or alternative service bundles (e.g., as approved by network technicians and/or business strategist as feasible and/or desirable services) can be added to the product catalog 223.

The example trouble management system 224 of FIG. 2 manages and correlates trouble issues (e.g., network service interruptions, poor performance, unwarranted denials of service, etc.) from a plurality of sources. The service provider 102 may receive one or more reports of one or more problems from one or more sources such as, for example, directly from a customer, from a customer support call center, from internal monitoring equipment, and/or any other source capable of determining and/or detecting fault(s) in network 110. The trouble management system 224 correlates the reports of problems into trouble tickets to be conveyed to one or more entities assigned to address such problems such as, for example, the customer care system 228.

The example ordering/provisioning system 226 of FIG. 2 conveys subscription orders (e.g., orders for service bundles) from customers to the policy manager 118. The example policy manager 118 of FIG. 2 develops and stores a policy for an ordering customer based on, for example, the specifics of the ordered service bundle, QoS parameters, geographic location of the ordering customer, bandwidth requirements, transmission speed requirements, etc.

The example customer care system 228 of FIG. 2 enables service representatives (e.g., call center staff, maintenance technicians, network engineers, programmers, etc.) of the service provider 102 to perform a plurality of tasks related to addressing customer concerns, problems, complaints, etc. For example, the customer care system 228 can support the service representatives in reviewing customer records, dispatching network technicians to address a network problem reported by a customer, etc. The example customer care system 228 and the trouble management system 224 may share responsibilities, operations, and/or tasks and/or may cooperate to complete such operations and/or tasks.

As described in greater detail below, the customer care system 228 is configured to interact with policy manager 118 to dynamically alter one or more aspects of the policy associated with the customer premises 104 during, after, and/or in connection with a customer care session and/or a maintenance session. When the customer care system 228 (e.g., a network technician) determines that one or more tests, analyses, evaluations, etc. of the network service being delivered to the customer premises 104 can be more easily, accurately, and/or quickly performed in light of adjustments to the policy (and, thus, the service bundle being delivered to the customer premises 104), the customer care system 228 conveys instructions to the policy manager 118 to modify the policy accordingly. The policy manager 118 determines whether the requested adjustment(s) are feasible and/or appropriate and, if so, makes the adjustments as requested.

The example network FCAPS statistic database 229 of FIG. 2 is a repository of network data having the capability to generate statistics indicative of network performance and/or behavior. That is, the FCAPS statistic database 229 includes one or more applications (e.g., computer implemented programs) to provide one or more metrics associated with the network 110 and/or the elements thereof. For example, a first application of the FCAPS statistic database 229 generates a metric related to the amount of bandwidth being used at a certain time in a certain location of the network 110 or at a certain customer premises (e.g., the first customer premises 104). The FCAPS statistic database 229 is capable of generating and storing other example metrics including, for example, an amount of service denials experienced by a certain group of customer residences (e.g., a geographically categorized group), a threshold amount of bandwidth corresponding to a level of available bandwidth that may cause network performance degradation, an amount of current video on-demand requests (e.g., by a geographically grouped set of customer premises), etc.

The example capacity/performance management system 230 of FIG. 2 assists network engineers in planning, designing, and/or maintaining end-to-end performance of the network 110. Network engineers or technicians use the capacity/performance management system 230 to, for example, manage bandwidth allocation(s) over the network 110 (e.g., by dynamically adjusting the amount of bandwidth allocated to certain network element(s) or customer premise(s) 104-108 based on the supply and demand for the bandwidth during a certain period of time). In the illustrated example, the capacity/performance management system 230 cooperates with and uses the resources of the FCAPS statistic database 229 to perform the operations described above.

The example billing system/usage mediation system 232 of FIG. 2 performs a plurality of operations related to tracking usage of the network resources on the part of the customers (e.g., individually and/or collectively) of the service provider 102. For example, the billing system/usage mediation system 232 receives call detail records (CDRs) from the policy enforcement point 202. The billing system/usage mediation system 232 compiles the CDRs into records associated with each customer for purposes of generating bills and/or reports including billing information (e.g., for internal analysis or accounting).

The example resource management system 234 of FIG. 2 includes inventory information corresponding to a state of the network 110 and the elements associated therewith (e.g., the network element 116, the switches, routers, gateways, and/or hubs of the network 110, CPE devices at the customer premises 104-108, etc.). The state of the network 110 is determined using data gathered from the network 110 (e.g., by the policy enforcement point 202 and/or the policy manager 118) and used to create an end-to-end topology of the network 110. That is, the resource management system 234 enables network technicians and/or elements of the policy manager 118 (e.g., the mediation and routing module 242) to gain an understanding of and/or analyze current capabilities of the network 110 (e.g., in reference to one or more of the customer premises 104-108). As described below in connection with the policy manager 118, the resource management system 234 is updated by the policy manager 118 to reflect any changes made in response to a dynamic policy setting request (e.g., a request by the customer 122 to adjust the allocation of the bandwidth at the premises 104 among the different communication devices 124, 126, and/or 128, a reallocation of network bandwidth to meet a surge in video on-demand requests in a particular geographic region, etc.). Further, the resource management system 234 may include a subscription profile database and/or cache to store information related to one or more customer subscriptions and the corresponding policies.

The example service creation environment 236 of FIG. 2 is a platform that enables and/or assists in creation of integrated services by bundling one or more product elements with a set of business rules. That is, the service creation environment 236 provides tools for assembling the service bundles described herein along with the associated business arrangements deemed suitable or desirable (e.g., according to revenue analyses, marketing studies, etc.) for the corresponding service bundles. In some examples, the service creation environment 236 includes testing equipment to ensure the feasibility of the integrated services and the corresponding policies.

The example policy manager 118 of FIG. 2 includes a testing environment 237, a master policy repository 238, a policy template creation module 239, a component library 240, a subscription/topology/device cache 241, a mediation and routing module 242, and a policy decision point 244. The example policy manager 118 of FIG. 2 is in communication with a terminal 246 through which a user (e.g., a network technician, engineer, programmer, etc.) can interface with the policy manager 118.

Generally, the example testing environment 237 enables technicians, engineers, programmers, designers, etc. to determine whether the network 110 (FIG. 1) is capable of supporting a certain service bundle, an element of the service bundle, and/or the policy corresponding to the service bundle. The example testing environment 237 is described in greater detail below in connection with FIG. 3.

The example policy repository 238 of FIG. 2 stores a plurality of rules to be used in creating the policies that define the service bundles to be provided to the customer premises 104-108. For example, some of the rules of the policy repository 238 can be used in creating and/or adding to a policy to include a type of data service. The type of data service is different according to, for example, different parameters associated with the data service (e.g., bandwidth, transmission speed, connection type, QoS) and/or the geographic location of the customer premises for which the policy is being created or modified. The rules of the policy repository 238 are used to create and/or modify additional or alternative aspect(s) of the policies described herein.

The example policy template creation module 239 receives information related to existing policies and/or policies in the development stages. The example policy template creation module 239 generates one or more templates to be used in association with the policies. As described above, the policies define different service bundles that are available to customers. When a customer selects a certain service bundle, information specific to that customer (e.g., geographic location, CPE device information, etc.) is entered into one or more of the policy templates generated by the policy template creation module 239 to assign the resulting policy to a premises associated with the customer. To generate the policy templates, the example policy template creation module 239 of FIG. 3 uses one or more policy components (e.g., standardized units or building blocks) stored in the component library 240.

The example subscription/topology/device cache 241 of FIG. 2 is used to obtain and temporarily store information related to the subscription(s) of customer(s) and the topology of, for example, the network 110. The subscription/topology/device cache 241 retrieves such information from, for example, the subscriber profile database 212, the policy enforcement point 202, the resource management system 234, and/or any other suitable source. Generally, the subscription/topology/device cache 241 provides the elements of the policy manager 118 faster access (e.g., relative to repeatedly retrieving the information from an external source) to information needed in performing the operations described herein (e.g., dynamic policy adjustments as described below in connection with FIGS. 3 and/or 4).

The example mediation and routing module 242 of FIG. 2 receives policy requests (e.g., the dynamic policy adjustment requests described herein) from the application access gateway 218. The mediation and routing module 242 validates the received requests (e.g., determines whether the requests are received from an authorized source) and routes the same to the policy decision point 244. In some instances, the mediation and routing module 242 directs the policy decision point 244 to set and/or modify the policies according to the request of, for example, a customer, a network technician, and/or a customer care representative. The mediation and routing module 242 of the illustrated example also receives additional or alternative information from other elements of the communication system 100. For example, the ordering/provisioning system 226 sends orders for subscriptions to the mediation and routing module 242, which validates and routes the orders to the policy decision point 244.

The example policy decision point 244 of FIG. 2 receives a plurality of requests from different components of the communication system 100. For example, the policy decision point 244 receives dynamic policy adjustment requests from the mediation and routing module 242 (e.g., from the application access gateway 218). The dynamic policy adjustment requests received by the example policy decision point 244 of FIG. 2 include, for example, requests to reallocate the bandwidth provided to the first customer premises 104 among the communication devices 124, 126, and/or 128. Another example dynamic policy adjustment request is a request to alter the policy assigned to the first customer premises 104 such that the customer 122 has access to a service or feature (e.g., temporarily to perform a certain task). The example policy decision point 244 queries one or more elements of the OSS/BSS 120 (e.g., the resource management system 234), the application servers 114 (e.g., the subscriber profile database 212), other elements of the policy manager 118 (e.g., the subscription/topology/device cache 241), and/or the network element 116 (e.g. the policy enforcement point 202) to gather information related to the particular dynamic policy adjustment request. In the illustrated example, the policy decision point 244 gathers information related to the requesting customer 122, the corresponding customer premises 104, the policy assigned to the customer premises 104, and information related to the network 110 and/or the state thereof. Using the gathered information, the policy decision point 244 determines whether a particular dynamic policy adjustment request is to be implemented based on, for example, whether the network 110, the customer premises 104, and/or any other element of the communication system 100 is capable of handling the requested alteration to the particular policy. Further, the policy decision point 244 of FIG. 2 uses the rules of the master policy repository 238 to create and/or modify the policy corresponding to the requesting customer 122. That is, the policy decision point 244 alters the policy assigned to the customer premises 104 in accordance with the customer request (and constrained by other factors such as network resource availability, contracted constraints (e.g., between the customer and the service provider), etc.) to increase the amount of network resources dedicated to one or more of the communication devices 124, 126, and/or 128 currently being used.

FIG. 3 illustrates an example physical interface architecture 300 through which the components illustrated in FIG. 2 interact and/or communicate. More specifically, FIG. 3 shows an example configuration for the example westbound interfaces 210 and the example northbound interfaces 222 of FIG. 2. While the example physical interface architecture 300 of FIG. 3 shows example instances of the northbound interfaces 222 and the westbound interfaces 210, the example instances of the northbound interfaces 222 and/or the westbound interfaces 210 may include additional and/or alternative components. The southbound interfaces 200 and the eastbound interfaces 204 may be implemented to the interfaces shown in FIG. 3.

Further, FIG. 3 illustrates example implementations of certain components of FIG. 2. For example, the policy testing environment 237 of FIG. 2 is shown in FIG. 3 as including test equipment 302, a test subscription/topology/device cache 304, a simulation environment 306, and a policy test result database 308. The testing equipment 302 includes tools, application, and/or programs (e.g., computer implemented programs) configured to enable testing of potential polic(ies) that define product(s) and/or service bundle(s). Generally, the testing equipment 302 enables technicians, engineers, programmers, designers, etc. to determine whether the network 110 (FIG. 1) is capable of supporting the policy, product, and/or service bundle being tested. The cache 304 stores information related to subscriptions, network topology, and devices associated with the network 110, the service provider 102, and/or the customer premises 104-108. The simulation environment 306 performs simulation(s) of network operation(s) with one or more policies being implemented on the network 110. That is, the simulation environment 306 provides predictive information regarding whether or not certain policies and/or the corresponding service bundles can be supported by the network 110 in such a manner that is desirable (e.g., profitable and/or technically feasible) to the service provider 102.

Further, the billing system/usage mediation system 232 of FIG. 2 is shown in FIG. 3 as including an account management unit 232a, a rating and charging and billing unit 232b, and a usage mediation unit 232c. The usage mediation unit 232c receives information from a charging system 308, which includes an off-line charging module 310 and an online charging module 312. The off-line and on-line charging modules 310 and 312 receive usage statistics or metrics from the network point of enforcement 202 (which is shown as part of the policy manager 118 in FIG. 3 but can be implemented externally of the policy manager in other examples) and the charging system 308 routes the same to the usage mediation unit 232c. The usage mediation unit 232c interprets and/or translates the usage statistics or metrics (e.g., according to a set of business rules and/or conversions) into data that can be used by the rating and charging and billing unit 232b and the account management unit 232a. The account management unit 232a and the rating and charging and billing unit 232b perform a plurality of administrative operations that result in the customer 122 being charged according to the network activity associated with the customer premises during a certain period of time (e.g., one month). Further, in the illustrated example, the rating and charging and billing unit 232b is in communication with a logging sub-system 314 implemented in the policy manager 118. The policy manager 118 may utilize the usage and/or billing information stored in the logging sub-system in any of a plurality of calculations, evaluations, analyses, etc.

Further, the policy decision point 244 of FIG. 2 is shown in FIG. 3 as including an enterprise policy decision point 244a and a distributed policy decision point 244b. The enterprise policy decision point 244a receives a plurality of requests (e.g., the dynamic policy adjustment requests described herein) from, for example, the mediation and routing module 242. The enterprise policy decision point 244a determines whether a requested policy (or a modification to be made to one or more policies) is to be implemented (e.g., based on whether the network 110, the customer premises 104, and/or any other element of the communication system 100 is capable of handling, for example, the requested alteration to the particular policy). The enterprise policy decision point 244a uses the rules of the master policy repository 238 to create and/or modify the policy corresponding to, for example, a request from the customer 122 to reallocate bandwidth among the communication devices 124-126 receiving the integrated service described above. The second policy decision point 244b performs substantially similar operations as the enterprise policy decision point 244a but acts in a local domain.

Further, the physical architecture 300 of FIG. 3 includes a first terminal 316 in communication with the policy template creation module 239 to enable a user to utilize the policy template creation module 239 in generating the policy templates described above in connection with FIG. 2. The physical architecture 300 of FIG. 3 also includes a second terminal 318 in communication with an exception handler 315. In the illustrated example, the exception handler 315 is an automated system to support the trouble management system 224. The exception handler 315 is also in communication with the policy manager 118 such that the policy manager 118 is informed of any potential problems or hazards associated with detected exceptions. For example, the exception handler 315 can inform the trouble management system 224 of repeated failures (e.g., rejected video on-demand sessions) at one or more customer premises 104, 106, and/or 108.

Further, the physical architecture 300 of FIG. 3 includes a policy platform statistical database 320 implemented in the example policy manager 118. The policy platform statistical database 320 receives information from the policy decision points 244a and 244b regarding the policies thereof and the evaluations and/or analyses performed thereon.

In the illustrated example, a first one 10 of the northbound interfaces 222 supports an interaction between the ordering/provisioning system 226 and the simulation environment 306. In particular, the first northbound interface 10 enables the ordering/provisioning system 226 to send test order(s) to the simulation environment 306 to test one or more metrics (e.g., an ordering policy setting flow) associated with an order generated by the ordering/provisioning system 226. As described above, the simulation environment 306 generates predictive information regarding whether or not certain policies and/or the corresponding product and/or service bundles can be supported by the network 110 in such a manner that is desirable (e.g., profitable and/or technically feasible) to the service provider 102. In the example of FIG. 3, the results generated by the simulation environment 306 are conveyed to and stored by the policy test results database 308.

In the illustrated example, a second one 12 of the northbound interfaces 222 supports interaction between the ordering/provisioning system 226 and the mediation and routing module 242. In particular, the second northbound interface 12 enables the ordering/provisioning systems 226 to convey service orders (e.g., live orders) to the mediation and routing unit 242 such that the mediation and routing unit 242 can facilitate (e.g., by conveying the service order(s) to the enterprise policy decision point 244a or the distributed policy decision point 244b) the setting of one or more policies corresponding to the received service order(s) from the ordering/provisioning system 226.

In the illustrated example, a third one 14 of the northbound interfaces 222 supports interaction between the service creation environment 236 and/or the product catalog 223 and the policy template creation module 239. In particular, the third northbound interface 14 enables the service creation environment 236 and/or the product catalog 236 to convey newly created product(s), service(s), and/or service bundle(s) to the policy template creation module 239 such that the policy template creation module 239 can generate a suitable template for the newly created product(s), service(s), and/or service bundle(s).

In the illustrated example, a fourth one 16 of the northbound interfaces 222 supports interaction between the service creation environment 236 and/or the product catalog 223 and the policy template creation module 239. In particular, the fourth northbound interface 18 enables the service creation environment 236 and/or the product catalog 223 to convey newly created business rule(s) to the policy template creation module 239 for use in generating new policy template(s).

In the illustrated example, a fifth one 18 of the northbound interfaces 222 supports interaction between the subscription/topology/device cache 241 and the resource management and subscription profile database 234. In particular, the fifth northbound interface 18 enables the subscription/topology/device cache 241 and the resource management and subscription profile database 234 to share and update information stored therein. For example, when the policy manager 118 receives, approves, and implements a dynamic policy adjustment request from the customer 122 (e.g., via the application access gateway 218, the policy assigned to the customer premises 104 is modified. The modification(s) to the policy are stored in the subscription/topology/device cache 241. In the illustrated example, the changes made to the policy, which are stored in the cache 241, are conveyed to the subscription profile database 234 of the OSS/BSS 120 via the fifth northbound interface 20, thereby synching the information related to adjusted policy assigned to the customer premises 104.

In the illustrated example, a sixth one 22 of the northbound interfaces 222 supports interaction between the policy enforcement point 202 and the off-line charging module 310. In particular, the sixth northbound interface 22 enables the policy enforcement point 202 to convey collected CDRs to the off-line charging module 310 such that the off-line charging module 310 can compile usage records and route the same to the usage mediation unit 232c and/or the network FCAPS database 229.

In the illustrated example, a seventh one 24 of the northbound interfaces 222 supports interaction between the policy enforcement point 202 and the on-line charging module 312. In particular, the sixth northbound interface 22 enables the policy enforcement point 202 to convey billing related requests and/or results to the on-line charging module 312 such that the on-line charging module 312 can compile online billing records and route the same to the usage mediation unit 232c and/or the network FCAPS database 229.

In the illustrated example, an eighth one 26 of the northbound interfaces 222 supports interaction between the logging sub-system 314 and the rating and charging and billing unit 232b. In particular, the eighth northbound interface 26 enables the rating and charging and billing unit 232b to retrieve billing transaction records from the logging sub-system 314 for purposes of, for example, auditing and/or tracing billing transactions.

In the illustrated example, a ninth one 28 of the northbound interfaces 222 supports interaction between the policy enforcement point 202 and the network FCAPS database 229. In particular, the ninth northbound interface 28 enables the policy enforcement point 202 to convey network statistic information to the network FCAPS database 229 for long term trending and/or traffic analysis.

In the illustrated example, a tenth one 30 of the northbound interfaces 222 supports interaction between the network FCAPS database 229 and the policy template creation environment 239. In particular, the tenth northbound interface 30 enables the network FCAPS database 229 to convey network statistics and/or analysis result(s) to the policy template creation environment 239, which uses the network statistics and/or analysis result(s) to tune (e.g., optimize) existing policy template(s). In some examples, in response to receiving certain network statistics and/or analysis result(s), the policy template creation environment 239 may trigger creation of a new policy template in addition to or in lieu of tuning existing policy template(s).

In the illustrated example, an eleventh one 32 of the northbound interfaces 222 supports interaction between the policy manager 118 (e.g., the policy decision point 244a and/or 244b) and the capacity/performance management system 230. In particular, when the policy manager 118 determines (e.g., via the enterprise policy decision point 244a) that network resources have reached a threshold (e.g., a level at or near a minimum amount of network resources deemed necessary to maintain proper service over the network 110), the policy manager 118 generates an alert indicating that network resources are depleted. In the illustrated example, the policy manager 118 conveys the alert, via the eleventh northbound interface 32, to the capacity/performance management system 230. In some examples, the capacity/performance management system 230 is configured to automatically detect the alert. The capacity/performance management system 230 manages network resources using, for example, bandwidth allocation(s), reroutes, and/or any other adjustments (e.g., temporary, periodic, or permanent modifications) to the network 110 and the elements thereof based on the current and/or near future demands on the network 110.

For example, in response to receiving a demand for a network resource (e.g., an on-demand video or one or more of the services/applications 220 of FIG. 2) from the customer 122, the policy manager 118 of the illustrated example determines whether the demand can be accommodated. In the illustrated example, this determination includes determining whether enough UniCast bandwidth is available in the network 110. Of course, the amount of available UniCast bandwidth is an example parameter to be analyzed by the policy manager 118 and additional or alternative parameters may factor into the determination made by the policy manager 118. If the customer demand cannot be met due to, for example insufficient network resources (e.g., when customers associated with the second and third premises 106 and 108 of FIG. 1 in the same geographic region as the first premises 104 also demand the network resource at a substantially similar time as the first customer 122), the policy manager 118 generates an alert and conveys the same, via the eleventh northbound interface 32, to the capacity/performance management system 230. As described above, the capacity/performance management system 230 attempts to address the network resource deficiency by adjusting the polic(ies) associated with the demanding customer premises in a manner that enables the network 110 to handle the large amount of demands and/or bandwidth.

In the illustrated example, a twelfth 34 one of the northbound interfaces 222 supports interaction between the policy decision point 244 (e.g., the enterprise policy decision point 244a and/or the distributed policy decision point 244b) and the customer care system 228. In particular, the twelfth northbound interfaces 34 enables the customer care system 228 to instruct the policy decision point 244 to alter one or more policies associated with one or more customer premises for a duration of a customer care session and/or maintenance session. As described above, the creation tests, analyses, evaluations, etc. can be more easily, accurately, and/or quickly performed by the customer care system 228 if the policies of the one or more customers are altered. Therefore, the twelfth northbound interface 34 supports the customer care system 228 by enabled a request to the policy decision point 244 to approve (e.g., via the testing environment 237) and implement a dynamic policy adjustment.

In the illustrated example, a first one 36 of the westbound interfaces 210 supports interaction between the mediation and routing module 242 and the application access gateway 218. In particular, the first westbound interface 36 enables the application access gateway 218 to convey the dynamic policy adjustment requests described herein to the mediation and routing module 242. As described above, the mediation and routing module 242 processes such requests and routes the same to the policy decision point 244 (which handles the possible adjustment of the subject polic(ies) as described herein). The application access gateway 218 receives the dynamic policy adjustment requests from, for example, the storefront 216 and/or from one or more of the services/applications 200 of the application servers 114 (FIG. 2). As described above, the storefront 216 and/or one or more of the services/applications 220 receive queries from the customer 122 (e.g., via the network element 116 of FIGS. 1 and 2) such as, for example, a request for access to one or more of the services/applications 220 and/or a reallocation of the integrated service delivered to the customer premises 104. In response to receiving such a request, the application access gateway 218 conveys the same to the policy decision point 244 via the first westbound interface 36 of FIG. 3.

In the illustrated example, a thirteenth one 38 of the northbound interfaces 222 supports interaction between the exception handler 315 and the trouble management system 224. In particular, the thirteenth northbound interface 38 enables the exception handler 315 to convey exceptions related to, for example, network functionality to the trouble management system 224. As described above, the trouble management system 224 manages and correlates trouble issues (e.g., network service interruptions, poor performance, unwarranted denials of service, etc.). Further, the trouble management system 224 forwards processed trouble issues (e.g., trouble tickets generated in response to an exception received from the exception handler 315) to the customer care system 228. As described above, if a certain amount of service faults, such as exceptions, occur at the customer premises 104, the policy manager 118 is configured to alter the policy associated with the customer premises 104 to maintain, for example, a QoS that the service provider 102 agreed to provide.

While an example manner of implementing the authentication/authorization module 112, the application servers 114, the network element 116, the policy manager 118, and the OSS/BSS 120 of FIG. 1 has been illustrated in FIGS. 2 and 3, one or more of the elements, processes and/or devices illustrated in FIGS. 2 and 3 may be combined, divided, re-arranged, omitted, eliminated and/or implemented in any other way. Further, the example southbound interfaces 200, the example policy enforcement point 202, the example eastbound interfaces 204, the example device manager 206, the example subscriber authentication/authorization module 208, the example westbound interfaces 210, the example subscriber profile database 212, the example enablers 214, the example storefront 216, the example application access gateway 218, the example services/applications module 220, the example northbound interfaces 222, the example product catalog 223, the example trouble management system 224, the example ordering/provisioning system 226, the example customer care system 228, the example network FCAPS statistic database 229, the example capacity/performance management system 230, the example billing/usage mediation system 232 (the example account management unit 232a, the example rating and charging and billing unit 232b, and the example usage mediation unit 232c), the example resource management system 234, the example service creation environment 236, the example testing environment 237, the example master policy repository 238, the example policy template creation module 239, the example component library 240, the example subscription/topology/device cache 241, the example mediation and routing module 242, the example policy decision point 244 (the example enterprise decision point 244a and the example distributed policy decision point 244b), the example test equipment 302, the example cache 304, the example simulation environment 306, the example policy test result database 308, the example off-line charging module 310, the example on-line charging module 312, the example logging sub-system 314, the example exception handler 315, the example policy platform statistical database 320, and/or, more generally, the example authentication/authorization module 112, the example application servers 114, the example network element 116, the example, policy manager 118, and/or the example OSS/BSS 120 of FIGS. 2 and/or 3 may be implemented by hardware, software, firmware and/or any combination of hardware, software and/or firmware. Thus, for example, any of the example southbound interfaces 200, the example policy enforcement point 202, the example eastbound interfaces 204, the example device manager 206, the example subscriber authentication/authorization module 208, the example westbound interfaces 210, the example subscriber profile database 212, the example enablers 214, the example storefront 216, the example application access gateway 218, the example services/applications module 220, the example northbound interfaces 222, the example product catalog 223, the example trouble management system 224, the example ordering/provisioning system 226, the example customer care system 228, the example network FCAPS statistic database 229, the example capacity/performance management system 230, the example billing/usage mediation system 232 (the example account management unit 232a, the example rating and charging and billing unit 232b, and the example usage mediation unit 232c), the example resource management system 234, the example service creation environment 236, the example testing environment 237, the example master policy repository 238, the example policy template creation module 239, the example component library 240, the example subscription/topology/device cache 241, the example mediation and routing module 242, the example policy decision point 244 (the example enterprise decision point 244a and the example distributed policy decision point 244b), the example test equipment 302, the example cache 304, the example simulation environment 306, the example policy test result database 308, the example off-line charging module 310, the example on-line charging module 312, the example logging sub-system 314, the example exception handler 315, the example policy platform statistical database 320, and/or, more generally, the example authentication/authorization module 112, the example application servers 114, the example network element 116, the example, policy manager 118, and/or the example OSS/BSS 120 of FIGS. 2 and/or 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example southbound interfaces 200, the example policy enforcement point 202, the example eastbound interfaces 204, the example device manager 206, the example subscriber authentication/authorization module 208, the example westbound interfaces 210, the example subscriber profile database 212, the example enablers 214, the example storefront 216, the example application access gateway 218, the example services/applications module 220, the example northbound interfaces 222, the example product catalog 223, the example trouble management system 224, the example ordering/provisioning system 226, the example customer care system 228, the example network FCAPS statistic database 229, the example capacity/performance management system 230, the example billing/usage mediation system 232 (the example account management unit 232a, the example rating and charging and billing unit 232b, and the example usage mediation unit 232c), the example resource management system 234, the example service creation environment 236, the example testing environment 237, the example master policy repository 238, the example policy template creation module 239, the example component library 240, the example subscription/topology/device cache 241, the example mediation and routing module 242, the example policy decision point 244 (the example enterprise decision point 244a and the example distributed policy decision point 244b), the example test equipment 302, the example cache 304, the example simulation environment 306, the example policy test result database 308, the example off-line charging module 310, the example on-line charging module 312, the example logging sub-system 314, the example exception handler 315, the example policy platform statistical database 320, and/or, more generally, the example authentication/authorization module 112, the example application servers 114, the example network element 116, the example, policy manager 118, and/or the example OSS/BSS 120 of FIGS. 2 and/or 3 are hereby expressly defined to include a tangible medium such as a memory, DVD, CD, etc. storing the software and/or firmware. Further still, the example authentication/authorization module 112, the example application servers 114, the example network element 116, the example, policy manager 118, and/or the example OSS/BSS 120 of FIGS. 2 and/or 3 may include one or more elements, processes and/or devices in addition to, or instead of, those illustrated in FIGS. 2 and/or 3, and/or may include more than one of any or all of the illustrated elements, processes and devices.

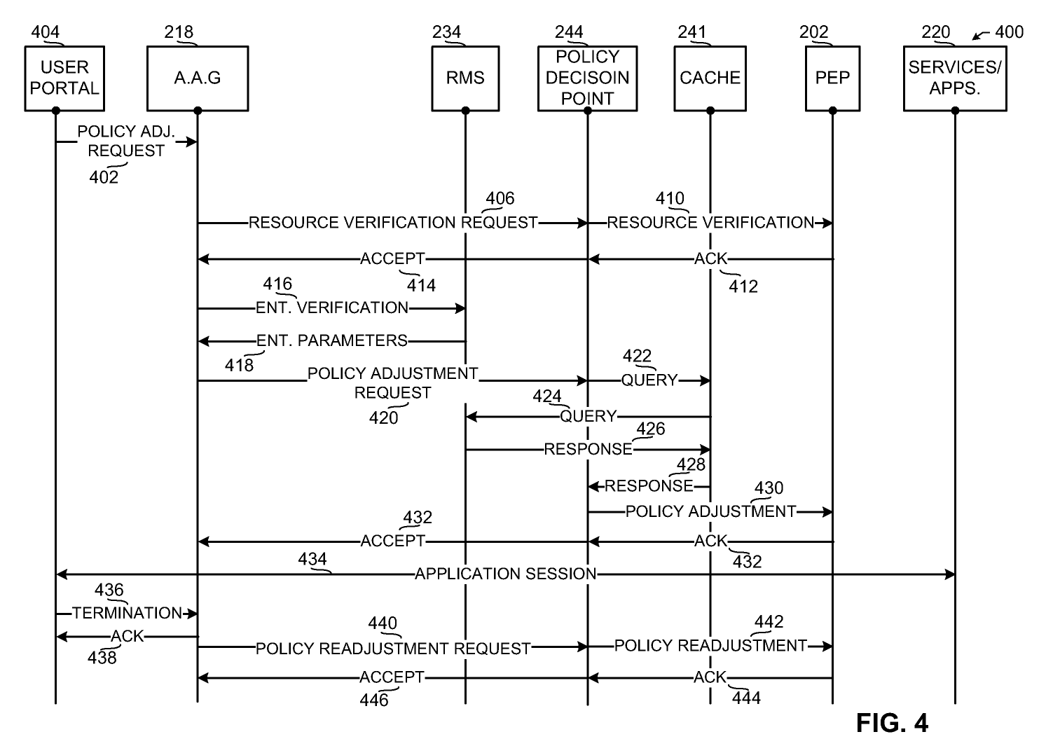

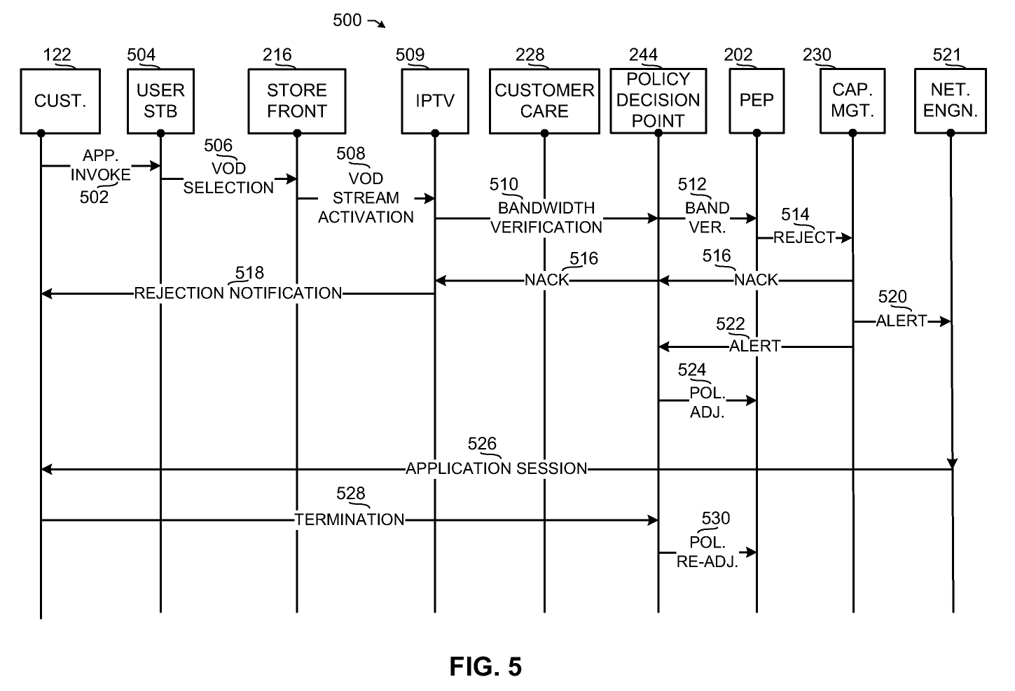

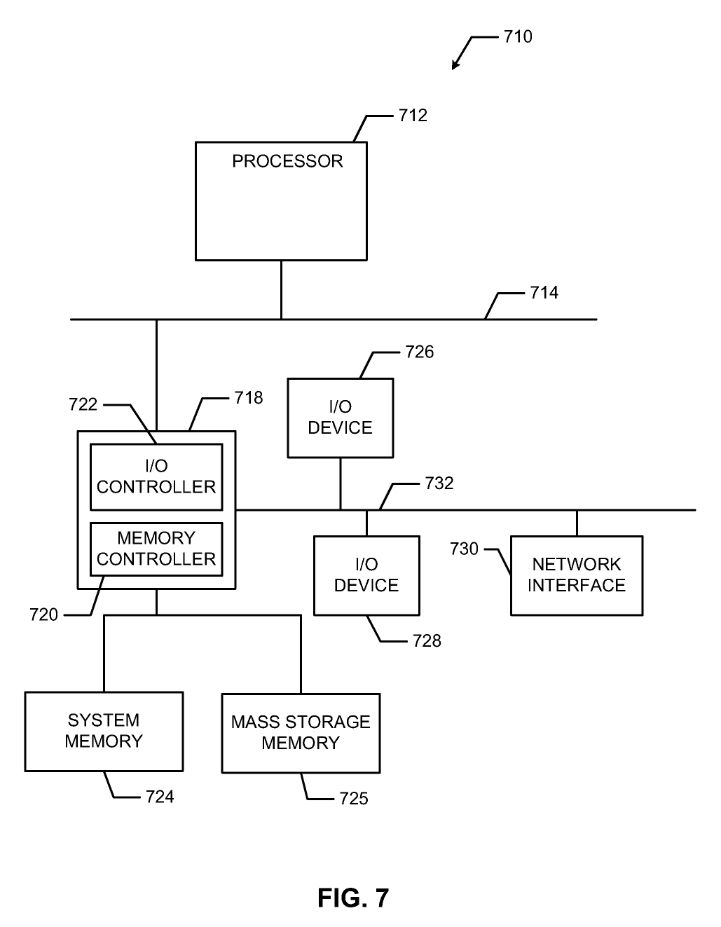

FIGS. 4-6 are sequence diagrams 400, 500, and 600 representing machine readable instructions that may be executed to implement the example components (e.g., the example authentication/authorization module 112, the example application servers 114, the example network element 116, the example, policy manager 118, and/or the example OSS/BSS 120) the of the example service provider 102 of FIGS. 1, 2, and/or 3. The example processes of FIGS. 4, 5, and/or 6 may be performed using a processor, a controller and/or any other suitable processing device. For example, the example processes of FIGS. 4, 5, and/or 6 may be implemented in coded instructions stored on a tangible medium such as a flash memory, a read-only memory (ROM) and/or random-access memory (RAM) associated with a processor (e.g., the example processor 710 discussed below in connection with FIG. 7). Alternatively, some or all of the example processes of FIGS. 4, 5, and/or 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 4, 5, and/or 6 may be implemented manually or as any combination(s) of any of the foregoing techniques, for example, any combination of firmware, software, discrete logic and/or hardware. Further, although the example processes of FIGS. 4, 5, and/or 6 are described with reference to the sequence diagram of FIGS. 4, 5, and/or 6, other methods of implementing the processes of FIGS. 4, 5, and/or 6 may be employed. For example, the order of execution of the operations may be changed, and/or some of the operations described may be changed, eliminated, sub-divided, or combined. Additionally, any or all of the example processes of FIGS. 4, 5, and/or 6 may be performed sequentially and/or in parallel by, for example, separate processing threads, processors, devices, discrete logic, circuits, etc.

The example sequence diagram 400 of FIG. 4 begins with a policy adjustment request 402. In the illustrated example, the policy adjustment request 402 is generated at a user portal 404 of the network 110 corresponding to the first customer premises 104. Further, the policy adjustment request 402 of FIG. 4 is accompanied by an invocation of an application or service by the customer 122 (e.g., using the voice equipment 124, the media presentation device 126, and/or the personal computer 128) at the customer premises 104. As described above, the service provider 102 provides the customer 122 with an option to convey the policy adjustment request 402 when the customer 122 desires a reallocation of services delivered to the customer premises 104. For example, if the customer 122 is downloading (e.g., using the personal computer 128) a large file from a file server of the network 110 or is performing any other operation that requires a significant amount of bandwidth or transmission speed (e.g., viewing an on-demand video on the media presentation device 126 or via an IPTV application), the customer 122 can send the policy adjustment request 402 to request the service provider 102 to allocate a greater percentage of the total bandwidth delivered to the customer premises 104 to the particular service (e.g., voice service, data service, or video service) that the customer 122 is currently using. This request can be made manually be the user or automatically by a device at the customer premises 104.

The policy adjustment request 402 is conveyed to the application access gateway 218. The application access gateway 218 conveys a resource verification request 406 to the policy decision point 244. In the illustrated example, the policy decision point 244 routes a resource verification 410 to the policy enforcement point 202. The policy enforcement point 202 determines a status of the network 110 and conveys an acknowledgement 412 regarding the currently available network resources to the policy decision point 244. In the illustrated example of FIG. 4, the policy decision point 244 conveys an acceptance 414 to the application access gateway 218 indicating that sufficient network resources are available to perform the operations associated with the invoked application (were insufficient resources available, the acceptance 414 would have been a denial). The application access gateway 218 responds to the acceptance 414 by conveying an entitlement verification 416 to the resource management system 234, which, as described above, can include a database and/or cache storing information related to the parameters associated with the requesting customer 122. The entitlement verification 416 is conveyed to the resource management system 234 to verify and/or determine parameters associated with the customer 122 and/or the customer premises 104 such as, for example, entitlement records, billing history, parental control, payment options, etc. If the resource management system 234 does not contain one or more of the desired parameters, the resource management system 234 can retrieve the same from other components of the OSS/BSS 120 (e.g., the billing system/usage mediation system 232). The resource management system 234 conveys entitlement parameters 418 back to the application access gateway 218.

The application access gateway 218 then conveys, via the first one 36 of the westbound interfaces 210 described above in connection with FIG. 3, a policy adjustment request 420 to the policy decision point 244. As described above, the policy decision point 244 queries one or more elements of the OSS/BSS 120 to gather information related to the particular policy adjustment request 420 that can be used in determining whether the policy adjustment request 420 can be or should be granted. In the illustrated example of FIG. 4, the policy decision point 244 sends a first query 422 to the subscription/topology/device cache 241. As described above, the subscription/topology/device cache 241 stores information related to the subscription(s) of the customer 122 (e.g., the policies defining the service bundle(s) to which the requesting customer is subscribed) and the topology of, for example, the network 110. To obtain such information, the subscription/topology/device cache 241 conveys a second query 424 to the resource management system 234. When the resource management system 234 returns a first response 426 including the requested information to the subscription/topology/device cache 314, the subscription/topology/device cache 314 conveys a second response 428 to the policy decision point 244.

Using the gathered information, the policy decision point 244 determines whether the policy adjustment request 420 is to be implemented based on, for example, whether the network 110, the customer premises 104, and/or any other element of the communication system 100 is capable of handling the requested alteration to the particular policy. Further, the policy decision point 244 of FIG. 2 uses the rules of the master policy repository 238 (FIGS. 2 and/or 3) to modify the policy corresponding to the requesting customer 122. For purposes of illustration, in the example of FIG. 4, the policy decision point 244 determines that the policy adjustment request 420 is to be granted and, thus, modifies the policy associated with the customer premises 104 as described above. In particular, the policy decision point 244 conveys a policy adjustment indication 430 to the policy enforcement point 202, which executes the policy as adjusted. The policy enforcement point 202 informs the application access gateway 218 of the policy adjustment by conveying an acknowledgement 432 back to the policy decision point 244, which conveys an acceptance indication 432 to the application access gateway 218.

The application that was invoked in connection with the policy adjustment request 402 generated at the user portal 404 is then executed during an application session 434. In the illustrated example, a termination 436 of the application leads to the adjusted policy being readjusted back to the original state of the policy (i.e., the state prior to the policy adjustment 430 executed by the policy decision point 244). In particular, the application access gateway 218 conveys an acknowledgement 438 of the termination 436 to the user portal. Further, the application access gateway 218 conveys a policy readjustment request 440 to the policy decision point 244. In response, the policy decision point 244 executes a policy readjustment 442 and conveys the same to the policy enforcement point 202. The policy enforcement point 442 then informs the application access gateway 218 of the policy readjustment by conveying an acknowledgement 444 back to the policy decision point 244, which conveys an acceptance indication 446 to the application access gateway 218. Thus, the service provider 102 can enable the customer 122 to dynamically control the manner in which network resources are allocated to individual services of an integrated service.

Turning to FIG. 5, as described above, a reallocation of network resources (e.g., bandwidth allocation among individual services of an integrated service being provided to the customer premises 104) can be automatically performed by the service provider 102 in response to detecting a threshold amount of service failures or session rejections that can potentially be avoided (e.g., temporarily or permanently) via the reallocation of network resource(s). The example sequence diagram 500 of FIG. 5 corresponds to such an example situation. The example sequence diagram 500 of FIG. 5 begins with an invocation 502 of an application or service by the customer 122. In the illustrated example, the invoked application or service is an on-demand video service. However, the example sequence diagram 500 of FIG. 5 is applicable to additional or alternative applications or services.

The customer 122 conveys the invocation 502 to a set-top-box 504. The set-top-box 504 conveys a video on-demand (VOD) selection 506 to the storefront 216. As described above, the storefront 216 is a portal to enable the customer 122 to access and/or purchase services such as the VOD service. The storefront conveys a VOD stream activation 508 to an IPTV application 509 (e.g., one of the services/applications 220 of the application servers 114 of FIG. 2). In response, the IPTV application 509 determines whether enough bandwidth is available for the set-top-box 504 to receive the requesting VOD stream. In particular, the IPTV application 509 conveys a bandwidth verification signal 510 to the policy decision point 244, which conveys the verification signal 512 to the policy enforcement point 202.

In the illustrated example of FIG. 5, the policy enforcement point 202 determines that the available bandwidth is insufficient to deliver the requesting VOD stream to the set-top-box 504. Thus, the point of enforcement 202 conveys a rejection 514 to the capacity/performance management system 230. The capacity/performance management system 230 generates a non-acknowledgement 516 and conveys the same to the IPTV application 509 via the policy decision point 244. The IPTV application 509 conveys a rejection notification 518 to the customer 122 informing the customer 122 of the inability to deliver the requested VOD stream.

Further, in response to receiving the rejection 514, the capacity/performance management system 230 generates a first alert 520 and conveys the first alert 520 to a network engineer 521. As described above, the network engineer 521 may perform any of a plurality of tests, analyses, etc. on the network 110 and/or the network resources associated with the customer premises 104. Moreover, the capacity/performance management system 230 generates a second alert 522 and conveys the second alert 522 to the policy decision point 244. As described above, the policy decision point 244 determines whether the amount of rejections similar to the last received rejection 514 is greater than a threshold. For purposes of illustration, in the example of FIG. 5, the policy decision point 244 determines that the threshold has been exceeded by the rejection 514 and, in response, executes a policy adjustment 524. Although not shown in FIG. 5 for purposes of clarity and brevity, the execution of the policy adjustment 524 may include additional operations (e.g., the first and second queries 422 and 424 and the corresponding responses 426 and 430 of FIG. 4 and/or determining whether the network 110 is capable of handling the requested adjustment using, for example, the testing environment 237). Further, the policy adjustment 524 may apply to the policy corresponding to the customer premises 104 and/or may apply to broader policies defining settings and/or configurations of a broader scope of the network 110. For example, the policy adjustment 524 of FIG. 5 may reallocate bandwidth among the communication devices 124, 126, and/or 128 of the customer premises. Additionally or alternatively, the policy adjustment 524 of FIG. 5 may include reconfiguring the manner in which the network 110 distributes VOD streams by, for example, allowing a greater amount of VOD sessions to be active at a given time.

The application that was invoked by the invocation 502 described above is then executed during an application session 526. In the illustrated example, a termination 528 of the application leads to the adjusted policy being readjusted back to the state of the policy before the policy adjustment 524 is executed by the policy decision point 244. In particular, an indication of the termination 528 is conveyed to the policy decision point 244 (e.g., via the application access gateway 218 not shown in FIG. 5), executes a policy readjustment 530 and conveys the same to the policy enforcement point 202. In some examples, there is no readjustment unless and until another event causes such readjustment.

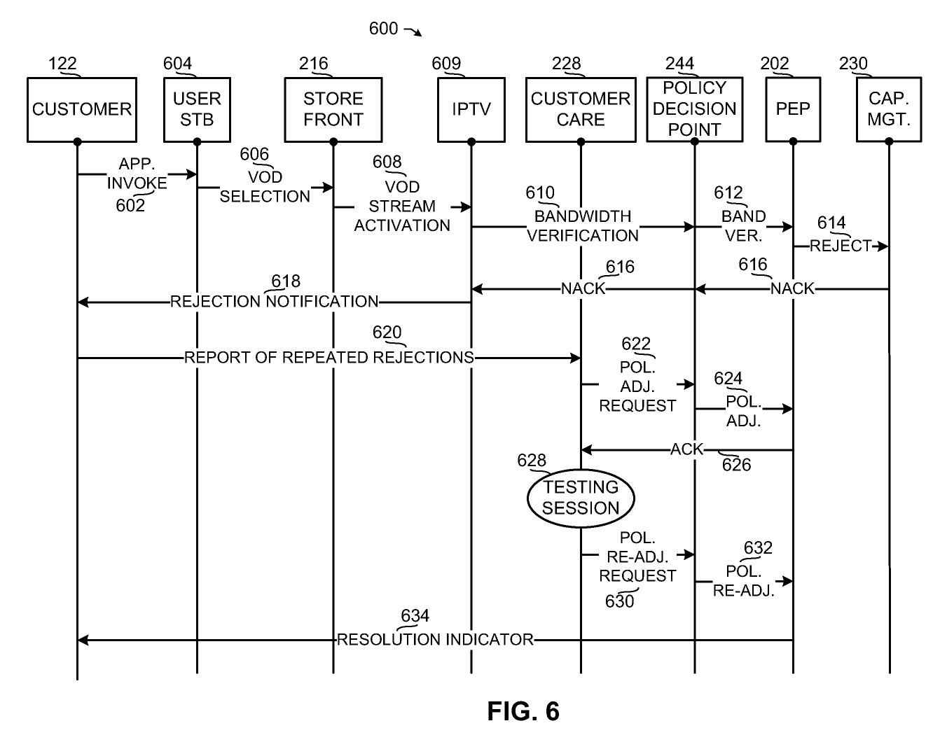

Turning to FIG. 6, as described above, a reallocation of network resources (e.g., bandwidth allocation among individual services of an integrated service being provided to the customer premises 104) can be performed by the service provider 102 during a customer care session and/or maintenance session. In particular, a member of the customer care system 228 can implement a policy adjustment to support a test, analysis, and/or any other operation used to address customer complaints and/or service failures. The example sequence diagram 600 of FIG. 6 corresponds to such an example situation.

For purposes of illustration, the example sequence diagram 600 of FIG. 6 begins in a similar manner as the example sequence diagram 500 of FIG. 5. In particular, the example sequence diagram 600 of FIG. 6 begins with an invocation 602 of an application or service by the customer 122. In the illustrated example, the invoked application or service is a video on-demand service. However, the example sequence diagram 600 of FIG. 6 is applicable to additional and/or alternative applications or services. The customer 122 conveys the invocation 602 to a set-top-box 604. The set-top-box 504 conveys a video on-demand (VOD) selection 606 to the storefront 216. The storefront conveys a VOD stream activation 608 to an IPTV application 609 (e.g., one of the services/applications 220 of the application servers 114 of FIG. 2). In response, the IPTV application 609 determines whether enough bandwidth is available for the set-top-box 604 to receive the requesting VOD stream. In particular, the IPTV application 609 conveys a bandwidth verification signal 610 to the policy decision point 244, which conveys the verification signal 612 to the policy enforcement point 202.

In the illustrated example of FIG. 6, the policy enforcement point 202 determines that the available bandwidth is insufficient to deliver the requested VOD stream to the set-top-box 604. Thus, the point of enforcement 202 conveys a rejection 614 to the capacity/performance management system 230. The capacity/performance management system 230 generates an non-acknowledgement 616 and conveys the same to the IPTV application 609 via the policy decision point 244. The IPTV application 609 conveys a rejection notification 618 to the customer 122 informing the customer 122 of the inability to deliver the requested VOD stream at the present time.

In some instances, the customer 122 contacts the customer care system 228 with a complaint and/or report of insufficient service. In the illustrated example of FIG. 6, the customer 122 conveys (e.g., via a call to a customer service call center associated with the customer care system 228) a report 620 of repeated rejections similar to the rejection associated with the rejection notification 618. In the illustrated example, the customer care system 228 determines that the addressing the report 620 and the corresponding issue(s) or problem(s) would be more easily or efficiently performed if the policy assigned to the customer premises 104 was adjusted (e.g., for the duration of a testing session) in some manner determined by the customer care system 228. That is, the customer care system 228 may determine that the reported problem can be better diagnosed if the policy was temporarily altered. Thus, the customer care system 228 conveys a policy adjustment request 622 to the policy decision point 244. In the illustrated example, the policy decision point 244 executes a policy adjustment 624 in response to the request 622. Although not shown in FIG. 6 for purposes of clarity and brevity, the execution of the policy adjustment 624 may include additional operations (e.g., the first and second queries 422 and 424 and the corresponding responses 426 and 430 of FIG. 4 and/or determining whether the network 110 is capable of handling the requested adjustment). Further, the policy adjustment 524 may apply to the policy corresponding to the customer premises 104 and/or may apply to broader policies defining settings and/or configurations of a broader scope of the network 110. For example, the policy adjustment 524 of FIG. 5 may reallocate bandwidth among the communication devices 124, 126, and/or 128 of the customer premises. Additionally or alternatively, the policy adjustment 524 of FIG. 5 may include reconfiguring the manner in which the network 110 distributes VOD streams by, for example, allowing a greater amount of VOD sessions to be active at a given time.

When the policy enforcement point 202 conveys an acknowledgement 626 of the executed policy adjustment 624, the customer care system 228 performs a testing session 628 with the adjusted policy in affect. In the illustrated example, the testing session 628 results in a resolution of the problem associated with the report 620. Thus, the customer care system 228 conveys a policy readjustment request 630 to the policy decision point 244. That is, the customer care system 228 requests that the adjusted policy be readjusted back to the state of the policy before the policy adjustment 624 is executed by the policy decision point 244. In response, the policy decision point 244 readjusts the policy and conveys the readjustment 632 to the policy enforcement point 202. The policy enforcement point 202 routes a resolution indicator 634 to the customer 122 as a notification that the service problem has been resolved.

FIG. 7 is a block diagram of an example processor system that may be used to execute the machine readable instructions of FIGS. 4, 5, and/or 6 and/or to implement the example components of the example service provider of FIGS. 1, 2, and/or 3. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are different, identical or similar to the processor 712 and that are communicatively coupled to the interconnection bus 714.

The processor 712 of FIG. 7 is coupled to a chipset 718, which includes a memory controller 720 and an input/output (I/O) controller 722. The chipset 718 provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method for use in a communication system, comprising:
receiving an adjustment request from a user premises to temporarily adjust a policy defining a bundled service associated with the user premises, the bundled service including a first service assigned a first percentage of a network resource and a second service assigned a second percentage of the network resource;
automatically adjusting the policy such that the first service is assigned a third percentage of the network resource, wherein the third percentage is greater than the first percentage;
receiving a notification of a termination of an application associated with the first service; and
readjusting the policy such that the first service is assigned the first percentage in response to the notification.

2. A method as defined in claim 1, wherein the network resource is a fixed amount of bandwidth assigned to the user premises.

3. A method as defined in claim 1, further comprising determining whether a network associated with the communication system is capable of implementing the adjustment request by verifying a status of the network resource.

4. A method as defined in claim 1, wherein the application associated with the first service comprises a video on-demand application.

5. A method as defined in claim 1, wherein the adjustment request is received via a customer care system.

6. A method as defined in claim 1, further comprising a third service assigned a fourth percentage of the network resource, wherein the first service comprises a data service, the second service comprises a voice service, and the third service comprises a video service.

7. A tangible machine accessible medium having instructions stored thereon that, when executed, cause a machine to:
receive an adjustment request from a user premises to temporarily adjust a policy defining an bundled service associated with the user premises, the bundled service including a first service assigned a first percentage of a network resource and a second service assigned a second percentage of the network resource;
automatically adjust the policy such that the first service is assigned a third percentage of the network resource, wherein the third percentage is greater than the first percentage;
receive a notification of a termination of an application associated with the first service; and
readjust the policy such that the first service is assigned the first percentage in response to the notification.

8. A tangible machine accessible medium as defined in claim 7 having instructions stored thereon that, when executed, cause a machine to determine whether a network associated with the communication system is capable of implementing the adjustment request by verifying a status of the network resource.

9. A tangible machine accessible medium as defined in claim 7, wherein the application associated with the first service comprises a video on-demand application.

10. A tangible machine accessible medium as defined in claim 7, wherein the adjustment request is received from a customer care system.

11. A tangible machine accessible medium as defined in claim 7, wherein the adjustment request is associated with a service complaint.

12. A tangible machine accessible medium as defined in claim 7, further comprising a third service assigned a fourth percentage of the network resource, wherein the first service comprises a data service, the second service comprises a voice service, and the third service comprises a video service.

13. A policy manager, comprising:
a memory to store a policy defining a bundled service including a first service assigned a first percentage of a network resource and a second service assigned a second percentage of the network resource, wherein the first and second services are delivered to a user premises;
a policy decision point to receive an adjustment request via a first interface, the policy decision point to adjust the policy such that the first service is assigned a third percentage of the network resource and the second service is assigned a fourth percentage, the third percentage being greater than the first percentage, the fourth percentage being less than the second percentage, and the policy decision point to readjust the policy such that the first service is assigned the first percentage in response to a notification of a termination of an application associated with the first service.

14. A policy manager as defined in claim 13, further comprising a policy template generator to generate a policy template to be used in creating the policy.

15. A policy manager as defined in claim 13, further comprising a policy enforcement point to execute the adjusted policy.

16. A policy manager as defined in claim 13, wherein the first interface enables a transfer of information between the policy manager and a application access gateway of an application server to exchange information associated with the adjustment request.

17. A policy manager as defined in claim 13, further comprising a second interface through which the adjustment request is received, wherein the second interface enables a transfer of information between the policy manager and an operational support system.

18. A policy manager as defined in claim 13, further comprising a test environment to simulate network conditions according to the adjusted policy before implementing the policy.

19. A policy manager as defined in claim 13, wherein the adjustment request is received from a customer care system.

20. A policy manager as defined in claim 19, wherein the customer care system performs a test of the first service when the first service is assigned the third percentage of the network resource.
